(19) United States
(12) Patent Application Publication
(10) Pub. No.: US 2008/0164626 A1
(43) Pub. Date: Jul. 10, 2008

(54) METHOD FOR THE PRODUCTION OF OPTICAL ELEMENTS AND OPTICAL ELEMENTS

(76) Inventors: Jose Zimmer, Losheim am See (DE); Ulrich Peuchert, Bodenheim (DE); Jochen Alkemper, Klein-Winternheim (DE); Yvonne Menke, Mainz (DE); Ina Mitra, Stadecken-Elsheim (DE)

Correspondence Address: Striker, Striker & Stenby, 103 East Neck Road, Huntington, NY, 11743, US

(21) Appl. No.: 11/968,722

(22) Filed: Jan. 3, 2008

(30) Foreign Application Priority Data
Jan. 9, 2007 (DE) 10 2007 002 079.3

(51) Int. Cl. B29D 11/00

(52) U.S. Cl. 264/1.21; 264/2.6

(57) ABSTRACT

The present invention relates to a process for producing optical elements, in particular lenses made from an optoceramic, comprising a forming step, which step comprises the formation of a green body. The invention further relates to optical elements produced according to the before mentioned process.

The process according to the present invention comprises a forming step including the application of a mould being close to the final geometry of the body to be formed (near net shape principle) including the application of moderate pressure between 0.1 MPa and 50 MPa, preferably between about 0.5 MPa and 25 MPa, in particular preferred between about 1 MPa und 12 MPa. The pressure is applied either on the ceramic powder mass during positioning of the ceramic powder mass into the form or is applied onto the ceramic powder mass within the form.

This invention relates to a method for the production of optical elements, especially lenses, from an opto-ceramic with a moulding step comprising the production of a green body, and further, the present invention relates to optical elements obtained by carrying out such a method.

Opto-ceramics can, due to their basically very convenient optical properties (refractive indices, dispersions), contribute to an improvement of optical imaging systems. In special cases, new imaging concepts are only possible with such new optical material options. Especially, the possibilities of more compact construction of, for example, digital cameras as well as improved or simplified colour corrections (chromatical or apochromatical) are mentioned here.

An opto-ceramic is substantially a single phase, poly crystallinic material based on oxides and having high transparency. Opto-ceramics are hence a subdivision of ceramics. Being a “single phase” material is to be understood in such a way that at least more than 95% of the material, preferably at least 97%, more preferably at least 99% and most preferably 99.5 to 99.9% are present in the form of crystals of the desired composition. The single crystals are densely packed and densities relating to the theoretical densities of at least 99%, preferably at least 99.9%, more preferably at least 99.99% are reached. Accordingly, the opto-ceramic is almost free of pores.

The crystal structure of the crystallites is preferably cubic. An example for this are garnets, cubically stabilised zirconium oxide, cubic sesquioxides like Y₂O₃, Yb₂O₃, Lu₂O₃, Sc₂O₃ and so on, or cubic mixed crystals of these oxides with each other or with other oxides called Al-oxinitrides, spinells or perovskites. As far as ZrO₂ is concerned, a stabilization of cubic symmetry is achieved by addition of certain oxides or mixtures of oxides in balanced amounts.

Compared to opto-ceramics conventional ceramics do not show the high densities observed in opto-ceramics. Thus, these are often compacted with sinter adjuvants. During sintering there very often occurs a high proportion of amorphous glass phase next to the crystalline phase that is mostly located near the grain boundaries. Also glass ceramics comprise high proportions of amorphous phases next to the crystalline phases, thus, neither these nor other conventional ceramics show the advantageous properties of opto-ceramics like for example certain refractive indices, Abbe numbers, values for the relative partial dispersion and, above all, the advantageous high transparencies for light within the visible range and/or infrared light. In the visible range of light the transmission is higher than 70% of the theoretical limit, preferably higher than 80% of the theoretical limit, especially preferred more than 90% of the theoretical limit, ideally the transmission is higher than 99% of the theoretical limit.

In certain applications opto-ceramics are therefore preferred over conventional lenses made of glass. A prerequesite for the successful placement on the market is the supply of sufficient amounts of high quality lenses with good reproducibility at acceptable prices. The prices are geared to the prices of conventional lenses made of glass.

Depending on their purpose of use, lenses comprise well specified curved surfaces cross their optical axis. Spherical lenses are limited by spherical segments, wherein the spheres' centres are located on the optical axis. Additionally, aspherical lenses and freely formed lenses are known.

The good mechanical and chemical properties are advantageous for the application of opto-ceramics as lense material. For example, opto-ceramics from the group of sesquioxides X₂O₃ show Knoop hardnesses HK_{0.1/20} according to DIN 9385 higher than those of quartz glass (Y₂O₃: ca. 750; Sc₂O₃: ca. 900); YAG (Yttrium-Aluminium-Garnet), spinell and ZrO₂ are even harder with Knoop hardnesses of 1300 and 1600, respectively.

On the other hand, a high hardness is undesired as far as workability of the lense is concerned. If the latter are produced from bulk material, the costs evolving from further process steps like for example CNC (Computerized Numerical Control) are considerable. Furthermore, conventional production processes are very often serially conducted methods showing low efficiency.

It is, hence, desirable to parallely conduct process steps, use multi-cavity moulds and minimize further process steps of the ceramics.

Additionally, mechanical properties like for example supporting areas, adjoining the lense circularly on the sides and thereby allowing positioning of the lense in the carrier, are often needed next to the optical functions. Even more complex mould recesses that are placed onto a local part of the lense might be needed in order to make integration into an optical system possible (monolithic optical elements). These recesses also increase costs and effort of further processing.

The production of ceramic components with high translucence and optical quality has been described many times. The method essentially comprises the following main steps:
1. powder production
2. powder conditioning
3. moulding
4. if necessary drying or debinding
5. sintering
6. HIP (hot isostatic pressing)
7. if necessary post annealing (thermic post processing)

The steps 4, 6 and 7 are optional and depend on the other process parameters and the properties of the desired ceramics.

The choice of the single process steps as well as the basic process parameters depend on a variety of factors. These factors are, for example, the powder properties (primary particle size, agglomerate size, specific surface, particle geometry), the physico-chemical behaviour of the specific material, especially during conditioning and sintering processes, the desired size/geometry of the product and/or the target size concerning the desired optical properties. Accordingly, the most purposeful process modules of the above-mentioned and those described below have to be chosen, where cost aspects are of relevance, too.

### 1. Powder Production

The production of opto-ceramics is achieved by use of suitable nanoscale powders. Those powders can be obtained by (co-)precipitation, flame hydrolysis, gas condensation, laser ablation, plasma spray methods (CVS method), sol-gel-techniques, hydrothermal methods, burning etc.

With a view to high packing densities, preferably round or spherical particle geometries are preferred, wherein the particles are loosely connected to each other by Vander-Waals forces (soft agglomerates). The particles are ideally connected to each other only by weak bridges in form of sinter necks. As far as chemical precipitation reactions are concerned, there is a great dependency on precipitation conditions in view of particle fraction and size. There is for example a large variety of basic powders obtainable by chosing the precipitation medium (carbonate, hydroxide or oxalate precipitation) of for example a nitrate or chloride solution of yttrium nitrate or yttrium chloride respectively.

Different drying methods of the filter cake (simple drying under air, lyophilisation, azeotropic distillation) can be applied to obtain powders of different qualities and properties (for example specific surface).

During precipitation further parameters have to be accounted for (pH value, stirring speed, temperature, precipitation volume, precipitation direction etc.).

The purity of the powder is an important criterion, too. Any impurity can lead to modified sintering conditions or inhomogeneous distributions of the optical properties. Impurities can furthermore lead to the development of liquid phases, which in turn lead to broad inhomogeneous grain boundary regions. The formation of intergranulary phases (amorphous and crystalline) is, however, not desirable, because this can result in differences in refractive indices leading to scattering loss during light passage.

The use of hard agglomerates, i.e. primary particles having built up multiple bridges during calcination, i.e. that are more or less caked to each other, is possible depending on the process. J. Mouzon describes in a publicly available “Licenciate Thesis” titled “Synthesis of Yb:Y₂O₃ Nanoparticies and Fabrication of Transparent Polycrystalline Yttria Ceramic”, Lulea University of Technology, Int. No. 2005:29 that for avoiding of intragranulary pores, i.e. pores within the particle, differential sintering is of advantage. This is assured by hard agglomerates. I.e. the primary particles within the agglomerate sinter densely and the pores are preferably located in the grain boundary regions. These could be removed from the structure by applying the method of hot isostatic pressing (HIP).

When producing (co-)precipitated powders there is the possibility to decrease the tendency to agglomerate by systematically adding additives. Thereby a grinding step is avoided. For example, before the calcination of a precipitatet oxalate suspension NH₄OH can be added.

### 2. Powder Conditioning

The powders are processed further depending on the moulding method to be applied. Usually, grinding is done in order to break agglomerates present in the powder on the one hand, and on the other hand to homogenize the powders by adding additives. Dry or wet grinding can be done, wherein for the latter alcohols or water based media are used. The expenditure of time for grinding can reach up to 24 hours, but should be chosen such that there appears no abrasions, neither from the grinding elements (Al₂O₃, ZrO₂) nor from the inner casing of the grinding barrel, because these abrasions represent impurities that should be avoided. As mill types annular gap, attrition, ball mills etc. are suited.

Dry or wet grinding can be done, wherein the medium can for example be water, liquid alcohol or liquid carbohydrates like heptanes or others.

Drying of the wet ground batches can be achieved under air at low temperatures, in the most convenient way the grinding suspension is dried by spray drying. With this method granules of defined size and quality can be obtained. In this way soft granules are produced advantageously. It is advisable to use binders during spray drying. The diameter of the agglomerates should not exceed 100 μm, agglomerates in the size range of from 10 μm to 50 μm are convenient, agglomerates with a size of lower than 10 μm are ideal. Lyophilisation and eddy current drying are imaginable, too.

### 3. Moulding

The step of moulding (moulding process or method) serves the purpose of moulding a pile of ceramic particles with external forces to such an extent that a green body is obtained and such that an enduring coherence is achieved, while the material is optimally homogenously compacted. There are extraordinarily manifold possibilities of ceramic moulding.

There are basically three main types of ceramic moulding. The moisture content of the basic material used (hereinafter referred to as powder masses) in each case serves as a criterion for the differentiation of the moulding techniques. Each main type of ceramic moulding—casting (25-40% moisture), plastical moulding (15-25% moisture) and pressing (0-15% moisture)—can be assigned different subtypes: casting is assigned, for example, slip casting, gel casting, pressure casting, film casting and electrophoresis. Plastical moulding comprises, for example, extrudation, squeezing, turning and free moulding. Pressing is for example differentiated into wet pressing, dry pressing, pounding and compacting by vibration.

An exceptional position is held by ceramic die casting. This method is not a casting method but a thermoplastic moulding method borrowed from plastics processing.

Of the above-mentioned moulding methods only dry pressing, slip casting, electrophoresis, ceramic die casting and gel casting have been mentioned in connection with the production of opto-ceramics.

For some moulding methods the additives mentioned in the following are necessary.
a) Solvents (water, organic solvents (mostly methyl ethyl acetone, trichloroethylene, acetone, alcohols, liquid waxes, refined petroleum, polymers (for example PVB, PVA) and mixtures thereof) are applied for the purpose of dissolving the particles.
b) By the use of surface active agents (polar and nonpolar surface active agents, ionic surface active agents, non-ionic surface active agents like for example ethoxylated nonylphenol or ethoxylated tridecylalcohol, sodium stearate or sodium diisopropyl naphthalene sulphate and dodecyl trimethylammonium chloride) the wettability of the particles by the solvent can be improved.
c) With liquidizer/dispersing agents agglomeration is avoided by electrostatic repulsion (water-based [aqueous] medium) or steric repulsion. Inorganic dispersing agents in a water-based medium are, for example, based on sodium carbonate, sodium silicate, sodium borate and tetrasodium pyrophosphate. Organic dispersing agents are preferably sodium polyacrylate, ammonium polyacrylate, sodium citrate, sodium succinate, sodium tartrate, sodium polysulphonate or ammonium citrate.
   Other liquidizers and dispersing agents, which are preferably used in the area of technical ceramics, are based on alkaline free polyelectrolytes, carboxylic acid esters as well as alkanolamines. Examples for strong polyelectrolytes are sodium polystyrene sulphonate (anionic) or polybiallyl dimethylammonium chloride (cationic), representatives of weak polyelectrolytes are polyacrylic acid (acidic) or polyethylene imine (basic). The properties of a polyelectrolyte solution are mostly determined by the repulsive interactions of the equally charged groups of the polymer chain.
   Further examples for dispersing agents are H₂O, ROH, C₇H₈ (toluene) and C₂HCl₃ (trichloroethylene), which avoid the agglomeration or flocculation of the powder particles by interacting with the powder surface.
d) Binders/flocculating agents are used in order to increase viscosity or suspend sedimentation of the particles. Furthermore, the binders can improve the mechanical resistance of the green body (advantageous for die casting and pressure casting). There colloidal binders (preferably used in the area of traditional ceramics) and molecular binders (polymers: ionic, cationic and anionic). Examples for synthetic binders are: polyvinyl alcohol (PVA), polyvinyl butyral (PVB), polyvinyl methacrylate (PMA) and polyacetals. Examples for binders of plant origin are cellulose, waxes, oils or paraffin.
e) Plasticising agents are applied in order to decrease the transformation temperature of a polymer binder to temperatures below ambient temperature. Examples for plasticising agents are remaining water, PVB, PMMA, light glycols (polyethylene glycol (PEG), glycerol), phthalates (dibutyl phthalate, DBP, benzyl phthalate, BBP) and others.

The use of additives in the production of opto-ceramics must—contrarily to the production of conventional, technical ceramics—be well-balanced, such that these additives are either totally burned during sintering or at least are reduced to the absolute minimum. Otherwise the high requirements concerning transparency (good transmission for visible light and/or UV-light) of the opto-ceramics could not be met, because amorphous areas would be formed, for example, at the grain boundary areas that could effect an undesired refraction of light and/or infrared radiation.

The additives are chosen in accordance with the moulding methods used. For moulding through casting, for example slip casting or pressure casting, the powder batch is dispersed in suitable liquidizers. For that purpose for example Darvan®, Dolapix®, polyarylic acids, ammonium oxalate (as monohydrate), oxalic acid, sorbitol, ammonium citrate or others.

Additionally, additives can be added in order to reduce the sintering temperature.

For thermoplastic moulding processes, like for example die casting, organic binders of the polyolefin type like HOSTAMOND® of Fa. Clariant, or catalytically disintegrating binders like that of the type CATAMOLD® of Fa. BASF, are applied to the powder and homogenised in a suitable way. In order to remove the binder from the component, supercritical carbon dioxide (CO₂) is used. In strongly compressed and heated carbon dioxide (T>31° C. and p>74 bar) certain binders are very well soluble. The component can thus be freed from the binder in comparably short time. It is, however, problematic that there is a risk of bubbles or tears occurring in the green body during degasification, which negatively affects the mechanical and optical properties of the component.

In the area of opto-ceramics the following moulding processes have been discussed up to now:

### 3.1 Compression Moulding

For the purpose of investigating laser effects for example Ikesue (J. Am. Ceram. Soc. 78, 1033) describes the production of rare earth doped YAG opto-ceramics. There, the nanoscale powder that has been granulated before is pre-moulded by uniaxial compression, whereby panes are formed. The high compaction is achieved by subsequent cold isostatic pressing.

A multitude of workgroups work on methods of compression moulding for the production of translucent and/or transparent ceramics. For example, DE 101 95 586 T1 describes the production of opto-ceramics with perovskite structure. There ‘ . . . the ceramic powder material is manufactured together with a binder to a predetermined form, such that a ceramic green compact is obtained . . . ’. At subsequent burning the ceramic green compact is preferably integrated into the specific powder. For processing of the ceramic powder material to a predetermined form a binder is used. According to an embodiment described in this document moulding is done by compression at 2000 kg/cm² (196 MPa) and leads to the production of panes with a diameter of 30 mm and 1.8 mm thickness. The lenses described in this document are produced such that round profiles are placed on the tile elements of the green compact by printing or layering with a doping agent. Multiple round forms grow to a lens form. After lamination of the single tile elements to obtain a tile and, afterwards, sintering, a tile is obtained that carries lenses that are either embedded into the tile or located at its surface.

All of the known works on opto-ceramics, making use of compression moulding, comprise manufacturing of so-called bulk material without taking into account the special geometry of the desired optical element (for example DE 10 2004 004 259, A. Ikesue and Y. I. Aung; Synthesis and Performance of Advanced Ceramic Lasers, J. Am. Ceram. Soc. 89[6] 1936-1944 (2006) and C. Huang et. al., Preparation and Properties of non-stoichiometric MgOnAl₂O₃ transparent ceramics, Chinese Journal of Materials Research, Vol. 20 No. 1 (2006)). The manufacture of opto-ceramics for the application of these necessary geometries by a compression moulding method has not yet been described.

The disadvantage of compression moulding is that on the one hand rather high pressures have to be applied that can cause tears in the green compact. Thereby the mechanical properties of the optical element present after production can be affected. On the other hand the pressure distribution in the green body is inhomogeneous so that the particles in the centre of the green body are not compacted as much as those particles located in the outer areas of the green body. Thereby also the subsequent sintering process is carried out inhomogeneously, too.

### 3.2 Moulding by Casting

JP 2092817 AA and JP 2283663 (Konoshima) disclose the production of yttrium aluminium oxide powders—with or without doping with rare earth elements and/or chrome—by precipitation and subsequent sintering in vacuum to obtain transparent ceramics with SiO₂-additive for mass production of multi-component ceramics of optical quality. The moulding of the green body is not described in detail.

JP 2003020288 A (Konoshima) as well as Ueda (‘Scalable Ceramic Lasers for IFE Driver’. Institute for Laser Science, Univ. of Electro-Communications, Japan-US Workshop ILE/Osaka, Mar. 13, 2003) describe the production of YAG ceramics obtainable by a slip casting process. In JP 2003020288 A the cylindrical polycrystalline element is connected to a single crystal laser rod after sintering.

US 2004/0159984 A1 describes the application of slip casting for the production of Y₂O₃ ceramics. A detailed description of the slip casting process is not disclosed in the document.

The disadvantage of slip casting is that the moulded body comprises a high binder content that has to be removed by debindering afterwards. This can lead to tears in the green body.

Gel casting is a variant of liquid moulding, wherein a few percent of polymerizable binders are added to the ceramic slip. Thereby high contents of solid material can be achieved, while the slip viscosity remains low and geometry stable green bodies are obtained that are manufactured by low-shrinkage pressure-less casting at room temperature, consolidation by polymerization (<80° C.) and drying.

In J. Am. Ceram. Soc. 89, 1985 (Prof. Krell, Fraunhofer Institut für Keramische Technologien und Sinterwerkstoffe, IKTS) the production of transparent Al₂O₃ ceramics is mentioned. These ceramics show—compared to specimen obtainable by compression techniques—a reduced porosity and, hence, improved transparency, because the freely mobile particles arrange themselves during gel casting. This leads to high homogeneity of particle concentration and, thus, to high transparency of the opto-ceramics obtained by this production process. Disadvantages of the gel casting method are that the mould must be secluded from air during gelling, because otherwise gelling would be hindered. This requires a great deal of energy. Furthermore, there must be high charge densities within the slip, thus a high solid content is needed. Such a slip is difficult to produce.

Clasen (Ber. DKG 82 (2005) No. 13) describes the advantages of electrophoresis in the production of transparent ceramics from cubically stabilised zirconium oxide. Especially advantageous is the fact that next to mono-modal powders also nanoscale powders with bimodal particle size distributions are useable. Background is the independency of mobility of particles from their size in the electrical field. Thus obtained are very compacted, homogeneous pore-free green bodies. Nevertheless, the achieved transmissions of the materials obtainable by the process described by Clasen are insufficient; the material is thus unsuited for the use as opto-ceramics. Especially, the use of this process for lenses with increased thickness is—as a consequence of the limitation of the achievable thicknesses (<==10 mm)—highly questionable.

As a result of the increasing insulating effect of the already deposited mass, the deposition rates of particles decrease with growing thickness.

### 3.3 Moulding by Die Casting

From a press release of Toshiba that was available in the internet in 2006 it is known that transparent YAG and Y₂O₃ based materials are obtainable by modified ceramic die casting. However, the experimental conditions were not mentioned.

In patent literature like for example DE 101 59 289 A1 advantages and disadvantages of ceramic die casting methods in connection with the production of optoceramics are summarized. The disadvantages are mostly related to the high contents of binders that are mixed with the powder in order to tune plastic viscosity. The binders have to be removed from the green compact after moulding and removing it from the mould. This takes place—depending on the type of binder used—thermally (polyolefines, Fa. Hostamond), catalytically (for example CATAMOLD) or by using supercritical CO₂. Mostly, cost intensive debindering ovens that thermally burn the developing carbohydrates have to be used. Additionally, after debindering there is often a body obtained that is porous and shows comparably low green density. This body is characterized by extensive shrinking during sintering. This can lead to tears in the body.

Furthermore, during die casting high pressures are applied, so that the orifices suffer strong wear. The moulds are furthermore very expensive, as they consist of hardened steel. Die casting is hence very cost intensive, especially with low and middle batch sizes.

### 4 Drying or Debindering

Details concerning drying or debindering according to the prior art and in connection with moulding in ceramic die casting can for example be found in the introduction of DE 101 59 289 A1. The formed bodies must, for example, be freed of synthetic polymers by a time consuming thermal, catalytical or solvent based debindering process.

As there is a high volume proportion of synthetic binder needed for binding the ceramic components, being constructed of very fine particles, within the binder-ceramic mixture, very porously formed components are obtained by debindering, so that tension arises within the material of the formed bodies leading to tears or inner structural faults, if debindering is carried out too quickly. Or, if the batch has been mixed with a water soluble binder, this can be washed out with water after moulding. Thus, within the areas of washed out binders channel structures are formed that increase the oxygen supply of the structure during sintering of the ceramic and furthermore lead to a significant reduction of the ceramic part and to tension in the ceramic material.

### Sintering

By sintering the single particles, which are still in loose contact to each other after moulding, build up solid contact by material transport and/or diffusion. Sinter necks are formed and open porosity is removed from the compacted powder.

Often sintering in vacuum is advantageous. Vacuum conditions above 10⁻³ mbar (=10⁻³ hPa), preferably between 10⁻⁵ and 10⁻⁶ mbar (=10⁻⁵ to 10⁻⁶ hPa) are used. The sintering conditions vary with the material. Sintering temperatures of 1400° C. to 1800° C. and sintering times of 1 to 10 hours are given as examples.

It is alternatively possible to sinter in special atmospheres (He, hydrogen (dry or moist), N₂, Ar).

When sintering under vacuum it is necessary to pay attention to the particle growth not becoming too fast and uncontrolled. It is an aim not to include any pores into the particles. This can be achieved by choosing relatively low sintering temperatures. The specimen may still be opaque due to the high pore density, but the pores are closed.

### 6 Hot Isostatic Pressing (HIP)

By subsequently applying a HIP process the closed porosity between the grain boundaries is pressed out of the structure. Exemplary conditions are temperatures between 1500° C. and 1800° C., pressures between 100 MPa (1000 bar) and 200 MPa (2000 bar). Annealing times of between 1 and 10 hours are usual (without heating and cool down). As a heating element W or Mo and, if necessary, graphite can be used.

As a pressurizing gas argon can be used. In order to avoid dissolution of Ar within the grain boundaries, for example in glassy regions, the specimen can be encapsulated or embedded in the specific powder.

### 7 Thermal Post-Processing

The ceramics, having been subject to the HIP process, can if necessary be thermally post-processed.

The thermal post-processing step is preferably done under air or oxygen. Exemplary conditions are 1 to 48 hours at temperatures of up to 1400° C.

In order to avoid solutions of Ar within the grain boundaries, for example in glassy regions, the specimen can be encapsulated or embedded in the specific powder. The latter can—depending on the material—avoid coloration through reduction of material on the surface or contamination of the specimen through components of the heating element present within the oven.

By applying a special process conduct, where the specimen is again sintered after the HIP step, oxygen vacancies and graphite impurities that have formed due to the atmosphere within the oven during the HIP step are removed, and thereby the intragranulary fine porosity is decreased. This happens through controlled particle growth, which takes place in such a way that newly built grain boundaries grow over the regions of the pores included into the particles. At this special process conduct the specimen is heated up to a temperature below the HIP temperature (for example 1450° C.) with a constant heating rate and left at that temperature in air for several hours.

Instead of vacuum sintering and subsequent HIP step, the combined process of vacuum hot pressing, i.e. uniaxial hot pressing under vacuum atmosphere can be used.

The production processes known from the art, especially the known moulding steps, do not allow for an efficient and cheap and, hence, economical production of optoceramics, while simultaneously providing for high transparency of the opto-ceramics. The drawbacks of the special methods are discussed above.

It is, hence, the object of the present invention to provide a cost-effective and efficient method for production of an optical element, especially a lens, consisting of an opto-ceramic and/or to provide a respective optical element.

The present invention is based on the idea to already use at least one near-net-shape mould in the moulding process step comprising the production of a green body of the optical element, such that already in this process step the geometry of the green body is fitted to the desired form of the optical element.

Herein near-net-shape moulding means in context with the present invention that the geometry of the produced green compact (green body with green form) is very close to the end shape of the sintered body. The body obtained after running through process steps 1 to 7 (ceramication route) shows the hereinafter called “raw form”. The body being post-processed by grinding, polishing, lapping, but without chemical milling (end product) has the shape that is hereinafter referred to as “product form”.

The near-net-shape green body together with the green form produced by a process according to the present invention basically corresponds in his aspect ratio to the raw form as well as to the product form. This means that green form and raw form as well as product form are related to each other like a equiangular and equally shaped image.

Time consuming post-processing steps of the raw form, conventionally carried out for example with CNC machines, are rarely necessary and, ideally, not necessary at all. Post-processing of the raw form is limited to polishing/lapping, and if necessary minor grinding.

It is possible that—depending on the material and production process—sintering does not work out homogeneously, which is due, for example, to density gradients within the green body and, hence, differential sintering. It is, however, preferred that the aspect ratio has only a deviation between green form and raw form of up to ca. ±10%, more preferably up to ca. ±5%, still more preferably up to ca. ±2%, and ideal is a deviation of ca. ±1% of the aspect ratio of the green form. The absolute volumes of green form and raw form may, however, depending on the chosen method, packing density and reactivity of the powder deviate significantly from each other. Volume shrinking rates can count up to 75% based on the volume of the green body and usually are above 10%.

The grinding and polishing effort of the raw form is reduced significantly due to the moulding method; ideally, there is no grinding necessary at all. The surface abrasion is minimized. Abrasion can for example count 2 mm, preferably 1 mm, more preferably 0.5 mm, most preferably 0.3 mm.

The specifications above concerning the difference of product/raw form are applicable in case that the method is used to obtain the whole lens, i.e. both functional areas are produced at once. In case, that the process can produce only one functional area (for example centrifugal casting), the opposite area must first be outlined (for example by chemical milling). In this case the partially finished lens, in which only one surface must be post-processed in a finishing process, is referred to as the product form. Further, in this case the terms green form, raw form and product form comprise the respective near-net-shape green contour, raw contour and product contour.

Additionally, moderate pressures of between 0.1 MPa and 50 MPa, preferably between ca. 0.5 MPa and 25 MPa, particularly preferred between ca. 1 MPa and 12 MPa are applied to the ceramic powder masses.

Thereby the green body acquires basic properties ideal for subsequent process steps, for example as far as homogeneity and green body compaction are concerned, so that the ceramic of the optical element at the end of the production process comprises the desired optical properties. Furthermore, the used moulds only suffer minor wear because of the moderate pressures; and cost-effective mould material can be used, so that the production process is cost-effective when compared to, for example, die casting.

The problem is furthermore solved by a process and an optical element obtained by a respective process. The optical element obtained by carrying out the specified process shows exceptionally good optical properties and can be produced simply and cost-effectively as well as with low expenditure.

The process according to the present invention makes high-volume and/or parallelized moulding for achieving a high green compaction and thus high theoretical densities within the ceramics possible, while simultaneously the binder content is kept as low as possible. Thus, an economical solution for the production of opto-ceramic elements, especially lenses, for consumer and industry applications is provided.

The present invention for the first time provides a process for the production of optoceramics of defined geometries, especially lens geometries, as it is excellently suited for the use of respective geometries. Thereby the necessary post-processing of the optical elements by grinding and polishing is minimized.

Particularly preferably the moulding process applied within the moulding step is selected from centrifugal slip casting or hot casting.

### Version A: Near-Net-Shape Centrifugal Slip Casting

It has surprisingly been found that in a combination of ceramic slip casting and centrifugation of a stable suspension into a plastic mould, through simultaneous centrifugal forces and the surface energy of the capillary walls within the mould material, an under-cut stable green body can be obtained, which can be sintered to a transparent lens. Centrifugation at 300-10000 rotations per minute, preferably at 1000-4500 rotations per minute, particularly preferably at 1000-3500 rotations per minute corresponds to the above-mentioned moderate pressures onto the batch within the mould due to the centrifugal forces.

As mould material the above-mentioned plastics can be used as well as ceramics or other inorganic material. As typical mould release agent, for example, boron nitride or graphite are used between mould and shaped casting. The inner side of the mould (bottom) can be concave, convex, planar or a free formed shape.

The advantage of centrifugal slip casting is that the liquids present in the processed material are collected on top of the green body and can, hence, easily be removed. It is furthermore a simple process that works very efficiently. Apart from that, many batches can be run simultaneously.

### Example for the Production of a Zro₂ Opto-Ceramic by Centrifugal Slip Casting:

First, the components are mixed in a ball mill for the production of the slip of nanoscale ceramic powder (35% by weight), solvent (51% by weight water), dispersant (5% by weight of a carboxylic acid ester), binder (4% by weight PVA), plasticizer (4.5% by weight glycerol, ethylene glycol and polyacrylate), anti-foaming agent (0.25% by weight) and surfactant (0.25% by weight). Afterwards the produced powder batch is transferred into the centrifuge and centrifuged at 3000 rotations per minute until the whole batch has settled on the bottom of the plastic (PMMA) mould, then centrifugation is continued for 15 minutes. Release from the mould and afterwards burning of the binder at 700° C. with a heating rate of 100 K/h and dwell time 8 h. Vacuum sintering takes place with a heating rate of 300 K/h up to 1300° C. and a dwell time of 10 h. HIP is afterwards carried out with a heating rate of 300 K/h up to 1500° C. and dwell time of 10 h and a pressure of 200 MPa. Then post-annealing is done at a temperature of 1100° C. under air with a heating rate of 150 K/min.

### Example for the Production of Y₂O₃ Opto-Ceramics by Centrifugal Slip Casting

A powder of the chemical composition Y₂O₃ with a specific surface area of 20 m²/g and a primary particle size of ca. 40 nm was processed to obtain a slip by adding different proportions of water as well as additives (liquefiers and/or binders, see columns 4 to 7 in the below table, specifications in % by weight):

| | | | | | | KV 5166 |
|---|---|---|---|---|---|---|
| | Y2O3 | water | sorbital | glycerol | Dolapix PC 21* | (defoaming |
| test | powder | (solvent) | (surfactant) | (plasticiser) | (liquefier) | agent) |
| 1 | 45 | 55 | 1 | 1 | 0 | 0 |
| 2 | 45 | 54 | 1 | 2 | 0 | 0 |
| 3 | 45 | 52 | 0 | 0 | 3 | 0 |
| 4 | 38 | 58 | 0 | 0 | 4 | 0 |
| 5 | 49 | 39 | 0 | 0 | 0 | 2 |

*Fa. Zschimmer & Schwartz

The slips were afterwards sufficiently centrifuged in a laboratory centrifuge Multifuge KR4 of Fa. Heraeus. This centrifuge reaches up to 400 rotations per minute. The specimen were centrifuged at rotations of ca. 9000 rotations per minute using a fixed angle rotor, this corresponds to a centrifuge acceleration of 12400 g (at g 9.81 m/s²). 11.5 g slip was filled into the test tube-shaped glassy specimen containers, at 13 mm diameter the fill level was ca. 60 mm. The pressure weighing on the specimen was ca. 10 MPa.

The bottoms of the mould had a special spherical shaped contour.

At centrifuging the solid particles sediment to the bottom of the vessel, the liquid is decanted. Afterwards the bodies are dried at 120° C./10 h. Debindering took place at 500° C./2 h.

At the end of the experiment there were obtained compacted, mechanically stable green bodies. The diameter, for example, was 12.5 mm.

The specimen were afterwards sintered and then subjected to hot isostatic pressing. Sintering took place in vacuum of 10⁻⁵ mbar, 1650° C. for 2 h. HIP was performed at 1800° C., 90 minutes at 200 MPa, and the pressurizing gas was Argon. The entire specimen led to transparent ceramics with high inline transmission of at least >70% of the theoretical limit.

### Version B: Near-Net-Shape Hot Casting

The Low Pressure Ceramic Injection Moulding (LP-CIM), also called low pressure warm injection or hot casting, utilizes low melting paraffin or waxes for plasticizing the ceramic powder. During hot casting the batch is transferred into the respective mould with the above-mentioned moderate pressure.

It has surprisingly been found that when using pure, homogeneous ceramic basic powder in connection with suitable thermoplastic binders (for example paraffin or waxes) and surface active ingredients a green body with homogeneous grain and particle size distribution can be obtained. During outgassing of the binders, it has to be taken care that no tears or bubbles are formed within the green body, which would negatively affect the mechanical and optical properties of the component. This can be achieved by suitably carrying out the process during burning of the binders and of the surface active ingredients. Thus, a ceramic body of high transparency can be obtained.

The temperature of the material filled into the hot casting mould is preferably between 60° C. and 110° C. The filling pressure is preferably between ca. 0.1 MPa and 5 MPa.

### Example for the Production of ZrO₂ Opto-Ceramics by Hot Casting:

The ceramic nanoscale powder is mixed together with the thermoplastic binder (mixture of 75% by weight of paraffin and 25% by weight of micro scale wax) and the surface active ingredient siloxane polyglycol ether (one molecular layer on the particle surface) at 80° C. in a heated ball mill. The viscosity of the final slip is 2.5 Pas at a solid material content of 60% by volume. The slip is then conveyed directly into the plastic mould with an injection pressure of 1 MPa (hot casting). Casting out of the binder takes place after release from the mould above the melting point of the wax used, wherein about 3% by weight remain in the green compact in order to provide for dimensional stability. The binders and surfactants still present in the green compact are burned during the subsequent sintering process. Vacuum sintering is performed with a heating rate of 300 K/h up to 1300° C. and a dwell time of 10 h. HIP is performed with a heating rate of 300 K/min up to 1500° C. and a dwell time of 10 h at a pressure of 200 MPa. Post-annealing takes place at a temperature of 1100° C. in air with a heating rate of 150 K/h.

In a preferred example short chain liquefiers and/or dispersants based on polyelectrolytes, carboxylic acid esters or alkanolamines are used if casting process are used as moulding methods in order to achieve an advantageous dispersion of the nanoscale ceramic particles. Thereby an electrostatic and/or steric repulsion of the nanoparticles can be achieved and a stable slip is obtained. It is advantageous, if the content of dispersants is between about 0.1 to 10% by weight, preferably between about 0.1 to 5% by weight, further preferred between about 0.1 to 3% by weight. Dispersion takes place in basic as well as in acidic milieu. It is generally true that the less dispersant is needed; the lower is the amount staying within the ceramic as impurity.

In the examples A and B the use additives is diligently adjusted in opto-ceramics contrary to technical ceramics—such that these additives are totally burned during sintering or at least kept at a minimum amount, because otherwise the extremely high transmissions could not be achieved (problem of grain boundaries).

In the production process according to the present invention suitable nanoscale basic powders of high purity, with a content of together 50 ppm (or less) of oxides of the following elements are preferably used: Zn, V, Ti, Pb, Mn, Ga, Cu and Cr. The powders preferably show a content of the above-mentioned oxides of 25 ppm or less.

Furthermore, the content of transition metals according to a preferred example of the process according to the present invention within the basic material is less than about 250 ppm, particularly preferred less than about 125 ppm; more preferred less than 75 ppm.

For the production process according to the present invention it is preferred that powders with primary particle size distributions and/or secondary particle size distributions with d50-values below 5 μm are used, preferably below 1 μm, particularly preferably below 500 nm, most particularly preferred below 100 nm.

Typical green body densities (without organic portion, i.e. after burning of the binders and surface active ingredients) are in the range of more than 30%, preferably more than 40%, particularly preferred more than 50%, more particularly preferred more than 60%, most particularly preferred more than 70% of the theoretical densities.

In a preferred embodiment of the present invention a temporary binder is used in the moulding step, which leaves small pores in the green compact during outgassing; said pores have a pore size of preferably <100 nm, more preferably <75 nm, particularly preferred <50 nm. Thereby the density of the obtained opto-ceramic can be increased.

The process according to the present invention is applicable to all types of active or passive opto-ceramics based, for example, on garnets (YAG, LuAG or others), sesquioxides (Y₂O₃, Lu₂O₃, Yb₂O₃ or others), cubically stabilized ZrO₂, HfO₂, spinel, AlON, perovskite or other material (mixture) systems with cubic crystal structure. Also non-cubic systems of opto-ceramics, like for example Al₂O₃, are obtainable by carrying out the processes according to the present invention.

Preferably, after the moulding step a drying step is carried out at temperatures of about 25° C. to 700° C. for about 1 h to 500 h, with a heating rate of about 5 K/min, preferably with a heating rate of about 2.5 K/min, particularly preferred with a heating rate of about 1 K/min. This drying step is carried out in order to remove liquids before moving to higher sintering temperatures, because otherwise the ceramic would burst during sintering. The drying step is done after the centrifugal slip casting as well as after hot casting.

The moulding step is always followed by thermal treatment as described in the prior art. These are especially sintering in air, special atmospheres (N₂, O₂, H₂, He, Ar) or preferably in vacuum, subsequent hot isostatic pressing, subsequent thermal post-processing in oxygen or air for re-oxidation of before reduced components.

A sintering step following the moulding and, if necessary, the drying step with the following conditions is particularly preferred:
vacuum of at least 10⁻³ mbar (=10⁻³ hPa), preferably between about 10⁻⁵ to 10⁻⁶ mbar (=10⁻⁵-10⁻⁶ hPa)
sintering time about 1 to 50 hours at temperatures between about 1400° C. and about 1800° C.
with a heating rate between about 2 to about 40 K/min and a characteristic cool-down curve of the oven or a cool-down rate of about 2 to 20 K/min. The sintering process is carried out in vacuum at quick heating rates in order to use possible surface defects of the powder and to have good sintering activity. Thereby a relaxation of the defects at lower temperatures is avoided. Additionally, first agglomerates are avoided and, thus, an improved density is achieved. The cool-down rate is relatively low, in order to avoid tensions during the cool-down phase and, hence, avoid tear formation.

Sintering is preferably followed by a HIP step at pressures between about 15 MPa (150 bar) and about 300 MPa (3000 bar), temperatures between about 1500° C. to about 2000° C. and dwell times of about 1 hour to about 50 hours (without heating and cool-down rates) with a heating rate of about 2 to about 20 K/min and characteristic cool-down curve of the oven or cool-down rate of about 2 to about 15 K/min. Particularly preferred W or Mo or graphite are used as heating elements. Further preferred the HIP step is carried out in inert atmosphere (for example argon or nitrogen). Analogical to the sintering step a quick heating rate is preferred during HIP step, too, in order to exploit possible surface defects for good sintering activity within the powder. Furthermore, a relaxation of defects at lower temperatures and the formation of first agglomerates are avoided, so that higher density can be achieved. The cool-down rate is low, in order to avoid tension and, thus, tear formation during cooling down.

The near-net-shape geometry is finally ground to the final shape and polished. Processing times and costs are significantly reduced due to the low need for material abrasion. In the case of aspheric geometries and free form surfaces a final zonal processing takes place (CNC, zonal polishing).

It is also imaginable to apply a glass layer onto the ceramic lens a) before and/or b) after final processing. This provides for either a) an in principal simpler material abrasion and/or b) remaining unevenness can be levelled again after polishing. Glass layers can be tight fit or precipitated (for example by applying the PVD method or similar coating methods).

Alternatively to post-processing of the ceramic the green body (i.e. before sintering), which is much softer in comparison to the ceramic body, can be mechanically post-processed. Next to the adjustment of the surface geometry, also drillings as well as recesses can be introduced.

The surface roughness that can be achieved after sintering and before post-processing is less than about 5 nm RMS (root mean squared roughness), preferably less than about 2.5 nm RMS, further preferred less than about 1 nm RMS and is calculated from the mean of the squared deviations.

The stress birefringence as a substantial quality criterion of the lens is below 100 nm/cm, preferably below about 50 nm/cm, particularly preferred below about 10 nm/cm and most particularly preferred below about 5 nm/cm after the production process is finished. As far as these values are not achieved, they can, if necessary, be adjusted by respective post-annealing. Exemplary conditions are a post-annealing time of about 1 to 48 hours at temperatures of up to 1450° C.

The dimensions of the lenses according to a preferred embodiment of the optical element according to the present invention are in the following ranges: diameter smaller than about 200 mm, preferably smaller than about 100 mm, particularly preferred smaller than about 50 mm, further preferred smaller than about 25 mm, still further preferred smaller than about 10 mm, still further preferred smaller than about 5 mm. The lenses show thicknesses of smaller than about 100 mm, preferably smaller than about 50 mm, particularly preferred smaller than about 25 mm, further preferred smaller than about 10 mm, further preferred smaller than about 5 mm.

The lenses can show a variety of surface contours (concave, convex, planar, spherical, cylindrical, free form).

The production process according to the present invention provides for an economical approach to a great multitude of geometries, hereunder are also monolithic optics, complex geometries with plane, convex, concave, spherical, aspheric surfaces and free form surfaces with refractive and reflective functions as well as drillings, undercuts, edges, recesses with mostly mechanical function for carriers, positioning, fixation, such that weight saving is achieved.

The lenses and/or monolithic components are suited for applications in a variety of areas like consumer optics (digital camera, cell phone camera etc.), industrial optics (large format objective, microscopy, endoscopy, lithography, data storage etc.) and military optics (high-strength components, IR transmissive optics, UV-vis & IR trans-missive optics etc.).

1. A process for the production of an optical element, especially a lens, consisting of an opto-ceramic, making use of a moulding step, said moulding step comprises the production of a green body, and the moulding step comprises the application of at least one near-net-shape mould, wherein moderate pressures of between about 0.1 MPa and 50 MPa, preferably between 0.5 MPa and 25 MPa, particularly preferred between about 1 MPa and 12 MPa, are applied either during filling of the ceramic powder into the mould on the powder batch or on the ceramic powder batch that is located in the mould.

2. The process according to claim 1, wherein the moulding method applied during the moulding step is selected from centrifugal slip casting or hot casting.

3. The process according to claim 1, wherein the opto-ceramic obtained by said process comprises single grains that show a cubic crystal structure.

4. The process according to claim 1, wherein the basic material has a purity such that the content of impurities is about <500 ppm, preferably about <100 ppm, more preferably <50 ppm, wherein the sum of the contents of transition metals is about <250 ppm, preferably about <125 ppm, more preferably about <75 ppm.

5. The process according to claim 1, wherein the casting method applied as moulding method comprises the application of short chain surfactants based on polyelectrolytes, carboxylic acid esters or alkanolamines as liquefiers and/or dispersants.

6. The process according to claim 5, wherein the content of the dispersants is between about 0.1 and 10% by weight, preferably between 0.1 and 5% by weight, further preferred between 0.1 and 3% by weight.

7. The process according to claim 5, wherein the dispersion takes place in basic as well as in acidic milieu.

8. The process according to claim 1, wherein during centrifugal slip casting colloidal and/or molecular binders (polymers: ionic, cationic and anionic) and/or synthetic binders (for example polyvinyl alcohol (PVA), polyvinyl butyral (PVB), polyvinyl methacrylate (PMA) and/or binders of plant origin (for example cellulose)) are used, said binders leaving small pores within the green compact upon outgassing, said pores preferably being smaller than about 100 nm, preferably smaller than about 75 nm, particularly preferably smaller than about 50 nm.

9. The process according to claim 1, wherein during hot casting paraffins, waxes, condensates, polyolefines, polybutyrals or polyalcohols are used as binders.

10. The process according to claim 8, wherein the amount of binders in the slip is about <30% by weight, preferably about <25% by weight, particularly preferred about <20% by weight.

11. The process according to claim 1, wherein the ceramic mass or the ceramic slip comprises sintering additives during moulding.

12. The process according to claim 11, wherein as sintering additives tetraethyl ortho-silicate (TEOS), alkaline or alkaline earth fluorides (for example LiF, MgF₂) and/or HfO₂ and/or ThO₂ are used.

13. The process according to claim 11, wherein the content of sintering additives in the slip is between 1 and 10% by weight.

14. The process according to claim 1, wherein after the moulding step a drying step is carried out at temperatures of about 25° C. to 700° C. for about 1 to 500 hours, with a heating rate of about 5 K/min, preferably with a heating rate of about 2.5 K/min, particularly preferred with a heating rate of about 1 K/min.

15. The process according to claim 14, wherein the green body shows a theoretical density (TD) after the drying step of 50% TD, preferably 60% TD, more preferably 70% TD.

16. The process according to claim 14, wherein the liquid content of the green body after the drying step is about <2.5% by weight, preferably about <1% by weight, particularly preferred about <0.5% by weight.

17. The process according to claim 1, wherein after the moulding step and if necessary also after the drying step a sintering step is carried out under the following conditions:
vacuum of at least 10⁻³ mbar (=10⁻³ hPa), preferably between about 10⁻⁵ to 10⁻⁶ mbar (=10⁻⁵−10⁻⁶ hPa);
sintering time about 1 to 50 hours at temperatures between about 1400° C. and about 1800° C.;
making use of a heating rate between about 2 to about 40 K/min and a characteristic cool-down curve of the oven or a cool-down rate of about 2 to 20 K/min.

18. The process according to claim 17, wherein a HIP (hot isostatic pressing) step follows the sintering step, wherein the pressures are between about 15 MPa (150 bar) and about 300 MPa (3000 bar), temperatures are from about 1500° C. to about 2000° C. and dwell times are about 1 hour to 50 hours (without heating and cooling rates) with a heating rate of about 2 to about 20 K/min and a characteristic cool-down curve of the oven or a cool-down rate between about 2 and about 15 K/min.

19. The process according to claim 18, wherein the heating element is W or Mo or graphite.

20. The process according to claim 18, wherein the HIP step is carried out in inert atmosphere (for example argon or nitrogen).

21. The process according to claim 18, wherein after the HIP step post-annealing is done for between about 6 to 48 hours in air at a temperature between about 1300° C. and 1450° C.

22. The process according to claim 21, wherein the heating and/or cool-down rate is between 2 K/min and about 15 K/min, preferably up to about 5 K/min, particularly preferred between 2 K/min and 3 K/min.

23. An optical element produced by a process according to claim 1.
